(19) United States
(12) Patent Application Publication
(10) Pub. No.: US 2002/0145264 A1
(43) Pub. Date: Oct. 10, 2002

(54) FOLDING STRUCTURE OF A SCOOTER

(76) Inventor: Chin-Lien Hung, Taichung Hsien (TW)

Correspondence Address: HARRISON & EGBERT, 412 MAIN STREET, 7TH FLOOR, HOUSTON, TX, 77002, US

(21) Appl. No.: 09/828,668

(22) Filed: Apr. 9, 2001

(51) Int. Cl. B62K 15/00

(52) U.S. Cl. 280/87.041; 280/87.05; 280/655.1

(57) ABSTRACT

A scooter folding structure comprises a footboard, a steering rod, a handlebar pivoted with the steering rod, and a connection rod provided with a movable member and fastened at one end with the steering rod and at other end with the front end of the footboard in conjunction with a locating rod. The locating rod is urged by the movable member to locate securely in first locating edges of the guide slots of the footboard at such time when the steering rod is kept in the upright position. When the steering rod is folded toward the footboard, the locating rod is urged by the movable member to locate securely in the second locating edges of the guide slots of the footboard.

### BACKGROUND OF THE INVENTION

1. Field of the Invention

The present invention relates generally to a scooter, and more particularly to a folding structure of the scooter.

2. Description of Related Art

The conventional scooter is generally provided with a folding structure to facilitate the folding of the scooter for easy storage and transportation. The conventional scooter folding structure is defective in design in that it is complicated in construction, and that its locating device does not work effectively.

### BRIEF SUMMARY OF THE INVENTION

It is the primary objective of the present invention to provide a scooter with a folding structure which is simple in construction.

It is another objective of the present invention to provide a scooter with a folding structure which has an effective locating device.

In keeping with the principle of the present invention, the foregoing objectives of the present invention are attained by a scooter comprising a steering rod, a handlebar fastened with the steering rod, and a footboard fastened at the front end with the steering rod by a connection rod in conjunction with a movable member and a seat body. The movable member has a receiving slot for accommodating two springs. A recovery spring is disposed between the movable member and the seat body. The steering rod and the handlebar are provided with locating means.

The features and functions of the present invention will be more readily understood upon a thoughtful deliberation of the following detailed description of the present invention in reference to the accompanying drawings.

### BRIEF DESCIPTION OF THE SEVERAL VIEWS OF THE DRAWINGS

FIG. 1 shows a perspective view of the present invention.

FIG. 2 shows an exploded view of the present invention.

FIG. 3 shows a side sectional view of the present invention in combination.

FIG. 4 shows a sectional schematic view of the present invention in action.

FIG. 5 shows another sectional schematic view of the present invention in action.

FIG. 6 shows still another sectional schematic view of the present invention in action.

### DETAILED DESCRIPTION OF THE INVENTION

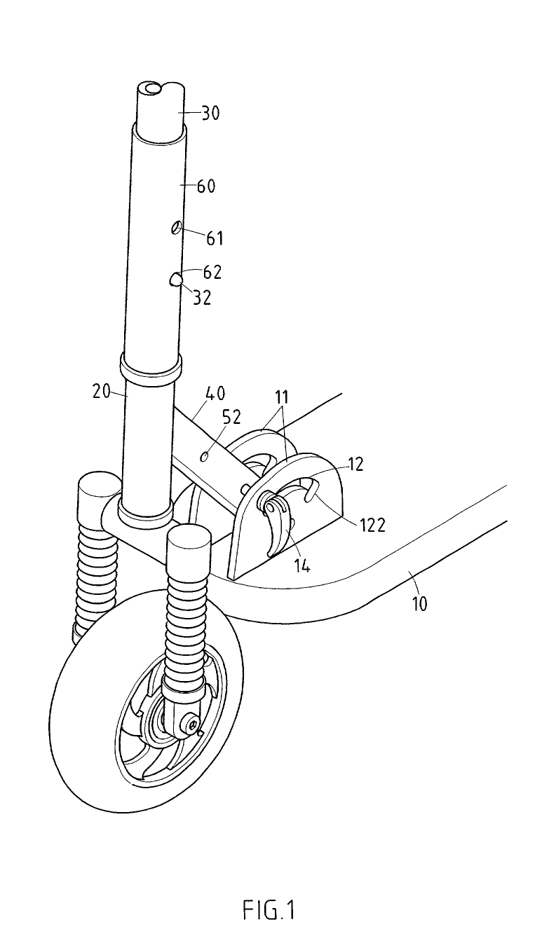

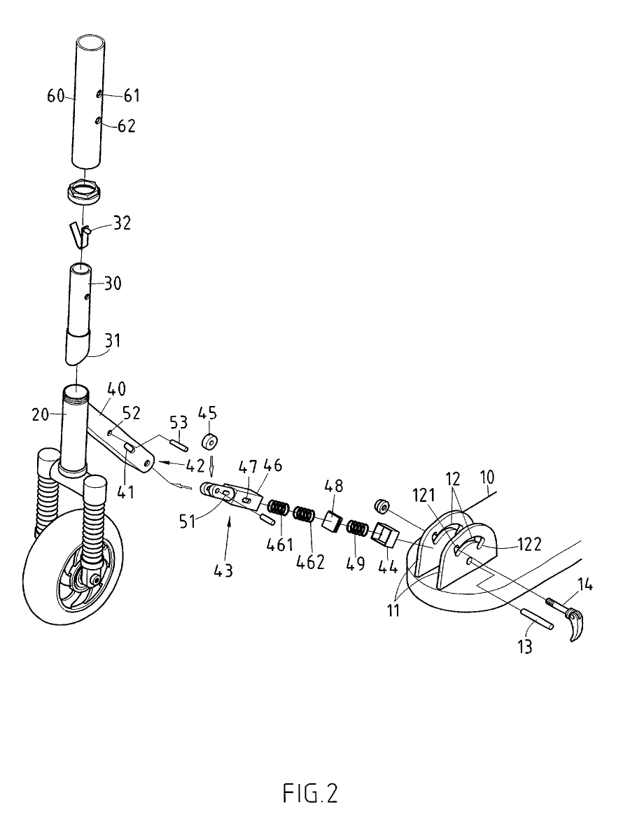

As shown in FIGS. 1-3, a scooter folding structure of the present invention comprises a footboard 10 which is provided on the upper side of the front end thereof with two frames 11 opposite to each other and having a guide slot 12 which is provided with a first locating edge 121 and a second locating edge 122. The present invention further comprises a steering rod 20, a handlebar 30 pivoted with the steering rod 20, and a connection rod 40 fastened at one end with the steering rod 20 and at other end with the front end of the footboard 10. The connection rod 40 is provided with a position confining slot 41 corresponding in location to the guide slots 12 of the two frames 11 of the footboard 10. The steering rod 20 is located by a locating rod 14 which is put through the guide slots 12 of the two frames 11 and the position confining slot 41 of the connection rod 40.

The present invention is characterized by the connection rod 40 which is provided in the interior with a through slot 42 in communication with the steering rod 20. A movable member 43 and a seat body 44 are disposed in the through slot 42 of the connection rod 40. The movable member 43 is pivoted at one end with a movable wheel 45 which is located at the juncture of the connection rod 40 and the steering rod 20. The movable member 43 is provided in the interior of other end thereof with a receiving slot 46 and is further provided at other end with a through hole 47 corresponding in location to the position confining slot 41 of the connection rod 40. The movable member 43 is further provided with a first spring 461 and a second spring 462, which are disposed in the receiving slot 46 of the movable member 43. The locating rod 14 is put through the guide slots 12 of the two frames 11. The position confining slot 41 of the connection rod 40, and the through hole 47 of the movable member 43 such that the locating rod 14 is urged by the first spring 461 and the second spring 462. The receiving slot 46 of the movable member 43 is provided with a cover 48. Located between the cover 48 of the receiving slot 46 and the seat body 44 is a recovery spring 49. The seat body 44 is rested against a pivot 13 which is used to pivot the connection rod 40 and the two frames 11 together. The movable member 43 is further provided with a first through slot 51 corresponding to a second through slot 52 of the connection rod 40. The movable member 43 is movably disposed in the through slot 42 of the connection rod 40 in conjunction with a blot 53 which is put through and confined in the first through slot 51 of the movable member 43 and the second through slot 52 of the connection rod 40.

The handlebar 30 is provided at the bottom end with an inclined plane 31 in contact with the movable wheel 45. The handlebar 30 is further provided in the outer wall with a locating projection 32. An outer tube 60 is provided in the tube wall with a plurality of locating holes 61 and 62, which are arranged at an interval along the longitudinal direction of the outer tube 60. The outer tube 60 is fitted over the handlebar 30 such that the outer tube 60 is located by the handlebar 30 by means of the locating projection 32 which is retained in the locating hole 61 or 62 of the outer tube 60.

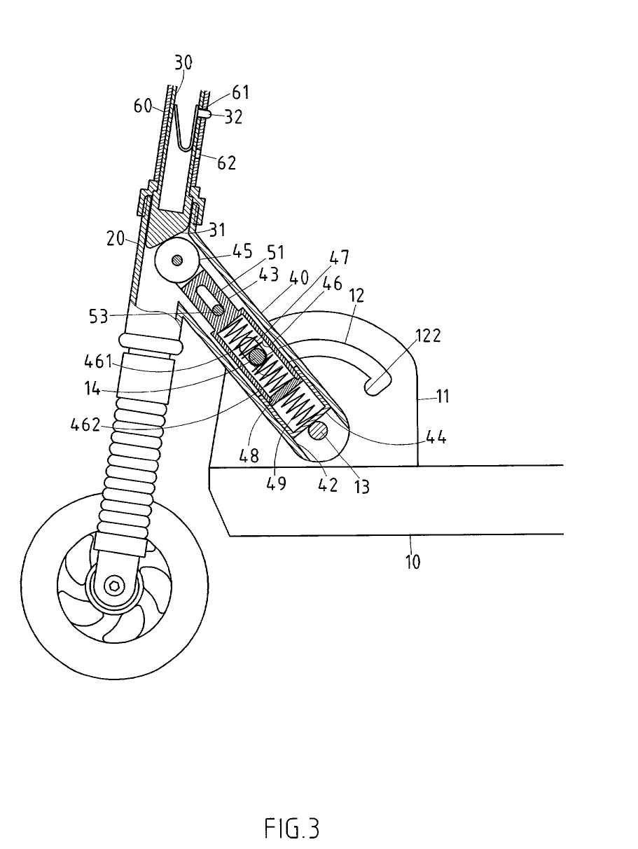

As shown in FIG. 3, when the steering rod 20 is located in the upright position, the locating projection 32 of the handlebar 30 is retained in the first locating hole 61 of the outer tube 60. In the meantime, the movable member 43 is urged by the recovery spring 49 such that the movable wheel 45 is pushed into the steering rod 20. The locating rod 14 is urged by the second spring 462 to be retained in the first locating edges 121 of the guide slots 12 of the frames 11.

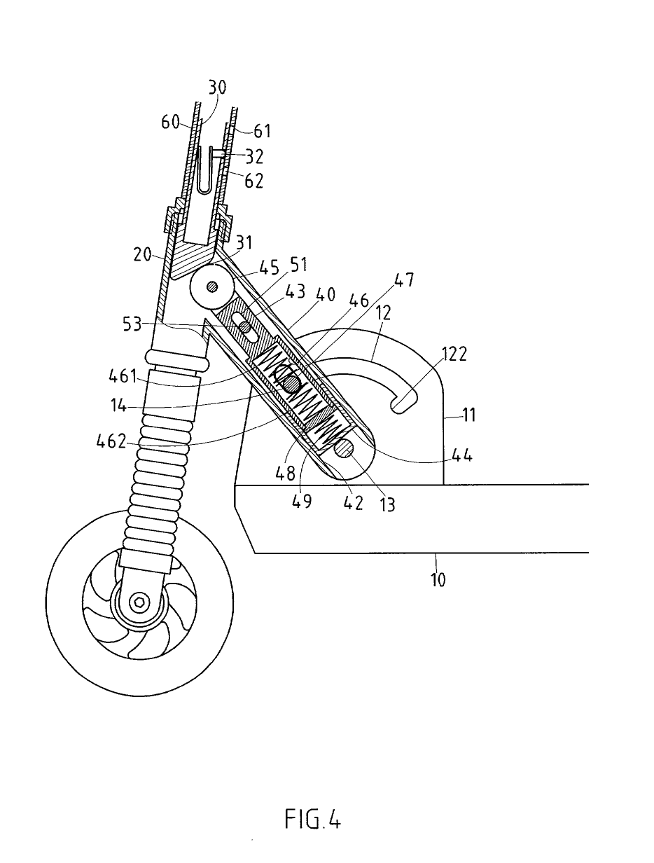

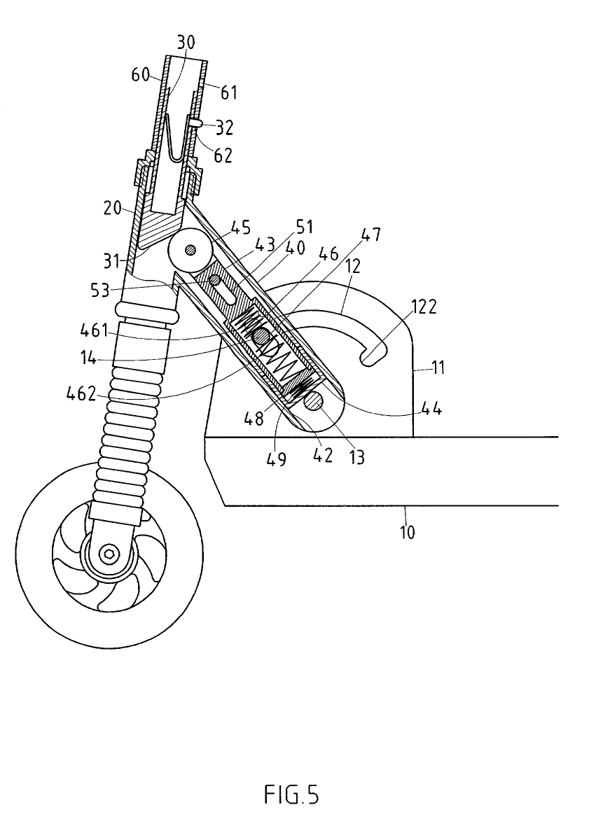

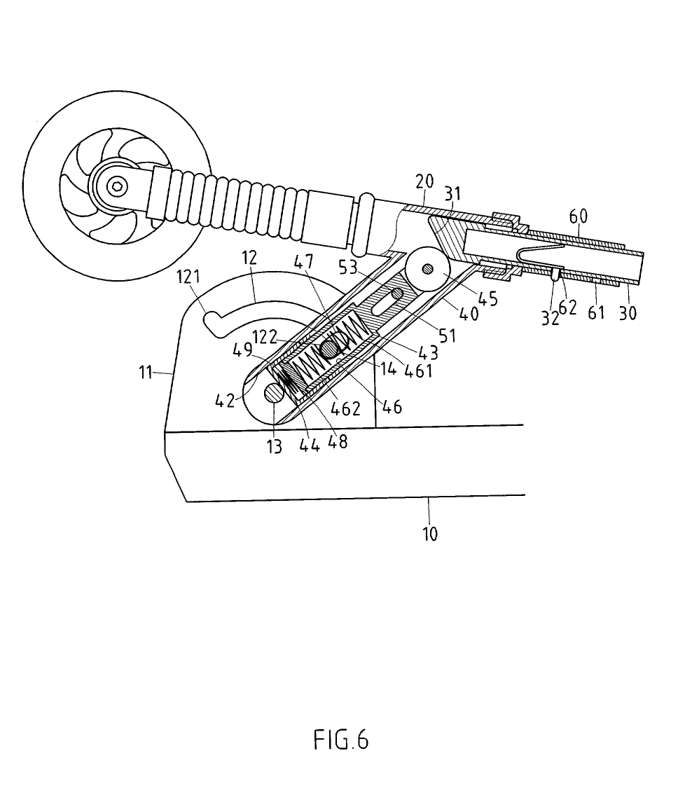

As illustrated in FIGS. 4-6, the steering rod 20 is folded toward the footboard 10 by first locating the locating projection 32 of the handlebar 30 in the second locating hole 62 of the outer tube 60. In the meantime, the movable wheel 45 is pushed by the inclined plane 31 of the handlebar 30 such that the movable member 43 is displaced downward to cause the first spring 461 to force the locating rod 14 to move into the second locating edges 122 from the first locating edges 121 of the guide slots 12 of the frames 11, as shown in FIG. 6. The recovery spring 49 is compressed. The locating rod member 14 is urged by the first spring 461 such that the locating rod member 14 is securely held in the second edges 122, thereby locating securely the steering rod 20 in the folding state.

I claim:

1. A folding structure of a scooter, said folding structure comprising a footboard, a steering rod, a handlebar pivoted with said steering rod, and a connection rod fastened at one end with said steering rod and at other end with a front end of said footboard, said footboard provided at the front end with two frames, each having a guide slot which is provided with a first locating edge and a second locating edge, said connection rod provided with a position confining slot corresponding in location to said guide slots of said two frames of said footboard, said steering rod being located by a locating rod which is put through said guide slots of said two frames and said position confining slot of said connection rod; wherein said connection rod is provided in an interior with a through slot in communication with a hollow interior of said steering rod, said connection rod having a movable member and a seat body which are disposed in said through slot of said connection rod, said movable member being provided with a movable wheel pivoted to one end thereof such that said movable wheel is located at the juncture of said connection rod and said steering rod, said movable member further provided at other end with a receiving slot and a through hole corresponding to said position confining slot of said connection rod, said movable member further provided with a first spring and a second spring, which are disposed in said receiving slot of said movable member, said locating rod being put through said guide slots of said two frames, said position confining slot of said connection rod, and said through hole of said movable member such that said locating rod is urged by said first spring and said second spring, said receiving slot of said movable member provided with a cover fastened therewith, said movable member further provided with a recovery spring which is located between said cover and said seat body, said seat body being rested against a pivot which is used to fasten pivotally said connection rod and said two frames, said movable member further provided with a first through slot corresponding to a second through slot of said connection rod, said movable member being movably disposed in said through slot of said connection rod in conjunction with a bolt which is put through and confined in said first through slot of said movable member and said second through slot of said connection rod; wherein said handlebar is provided at a bottom end with an inclined plane in contact with said movable wheel, said handlebar further provided in an outer wall with a locating projection, said handlebar being fitted into an outer tube which is provided with a first locating hole and a second locating for retaining said locating projection of said handlebar; wherein said steering rod is located in an upright position such that said locating projection of said handlebar is retained in said first locating hole of said outer tube, and that said movable member is urged by said recovery spring, and further that said movable wheel is pushed into said steering, and further that said locating rod is urged by said second spring to be retained in said first locating edges of said guide slots of said two frames of said footboard whereby said steering rod is folded toward said footboard by first locating said locating projection of said handlebar in said second locating hole of said outer tube, thereby causing said inclined plane of said handlebar to push said movable wheel to displace to cause said first spring to force said locating rod to move into said second locating edges from said first locating edges of said guide slots of said two frames of said footboard.
